(19) United States
(12) Patent Application Publication
(10) Pub. No.: US 2014/0195448 A1
(43) Pub. Date: Jul. 10, 2014

(54) Social Location Data Management Methods and Systems

(71) Applicant: WHERE 2 GET IT, INC., Anaheim, CA (US)

(72) Inventors: Jon Scarbrough, Anaheim, CA (US); Manish Patel, Anaheim, CA (US)

(73) Assignee: WHERE 2 GET IT, INC., Anaheim, CA (US)

(21) Appl. No.: 14/150,312

(22) Filed: Jan. 8, 2014

Related U.S. Application Data
(60) Provisional application No. 61/750,097, filed on Jan. 8, 2013.

(51) Int. Cl. G06Q 10/10; G06Q 50/00

(52) U.S. Cl. CPC G06Q 10/10; G06Q 50/01
USPC 705/319; 705/342

(57) ABSTRACT

Disclosed is a system for managing internet-based location data by periodically requesting and receiving information relating to the identification of a storefront or business. The system can obtain this information by interfacing with the application programming interface (API) of a website or otherwise searching the website and periodically retrieving identifying data from the website. The system can then match the retrieved identifying data with actual identifying data of a storefront or business to determine the accuracy of the client-stored identifying information. Results of this matching can then be distributed to the end user via the server, or output to external store locator functionality to help consumers locate the storefront or business.

### RELATED APPLICATIONS

This application claims priority to U.S. Provisional Application No. 61/750,097, filed Jan. 8, 2013, the contents of which are hereby incorporated by reference in their entirety.

### TECHNICAL FIELD OF THE INVENTION

The present application relates to management of data stored on the Internet. Particularly, the present application relates to management of a company or person's location based data displayed on a network such as the internet.

### BACKGROUND OF THE INVENTION

Social networks are commonly used to market a company or storefront to users of a network such as the internet. For example, companies use social network websites such as Foursquare®, Google+®, Facebook® and Twitter® to publish data indicating the location, phone number, address, or other identifying information of a storefront. The location data found in these social network websites can originate from a variety of sources, e.g., consumers, data aggregators, store owners, franchisers, corporate IT departments, and the like. As a result, it can be difficult to ensure that published location data is accurate among all network sites due to the inherent nature of how the data is acquired. For example, consumers may enter only partial data, data aggregators may repeat errors from other sources, one set of identifying data may be a duplicate of another set, or store owners may forget to update data as it changes.

### SUMMARY OF THE INVENTION

The present application discloses a system for managing Internet-based published location data by periodically requesting and receiving information relating to the location of a storefront or business. As an example, the system can interact with an application programming interface (API) of a network site and periodically retrieve identifying data from the network site. The system can then match the retrieved identifying data with a queue entry for each storefront to determine the accuracy of the client-stored information. Results of this matching can then be distributed to the end user via the server, or output to store locator functionality to help consumers locate the storefront or business.

In particular, the present application discloses a method of managing data including storing actual identifying data of a merchant indicating an actual identification of a storefront or business representing the merchant, receiving a data retrieval job request from a user requesting a comparison between the actual identifying data and published identifying data representing a published identification of the storefront or business representing the merchant, receiving the published identifying data from a client, comparing the published identifying data with the actual identifying data, determining an accuracy of the published identifying data to obtain a result of the step of comparing, and transmitting the result.

Also disclosed is a system of managing data including a server having stored thereon actual identifying data of a merchant indicating an actual identification of a storefront or business representing the merchant, a client having published thereon published identifying data representing a published identification of the storefront or business representing the merchant, a transceiver adapted to receive a data retrieval job request from a user requesting a comparison between the actual identifying data and the published identifying data, and further adapted to transmit a client request to the client requesting the published identifying data from the client, wherein the server is further adapted to compare the published identifying data with the actual identifying data and determine the accuracy of the published identifying data to obtain a comparison result, and wherein the transceiver is further adapted to transmit the comparison result.

Further disclosed is a non-transitory computer-readable medium operatively coupled to a processor and capable of executing instructions to store actual identifying data of a merchant indicating an actual identification of a storefront or business representing the merchant, instructions to receive a data retrieval job request from a user requesting a comparison between the actual identifying data and published identifying data representing a published identification of the storefront or business representing the merchant, instructions to request the published identification data from a client, instructions to compare the published identification data with the actual identification data, instructions to determine an accuracy of the published identification data to obtain a result of the step of comparing, and instructions to transmit the result.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of a network embodiment according to the present application.

FIG. 2 is a flowchart illustrating a process according to an embodiment of the present application.

FIG. 3 is a flowchart illustrating a process for acquiring information from a client, such as a social network, according to an embodiment of the present application.

FIG. 4 is a flowchart illustrating a process for matching the acquired data against stored data according to an embodiment of the present application.

FIG. 5 is a flowchart illustrating a process for reporting the matched results according to an embodiment of the present application.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

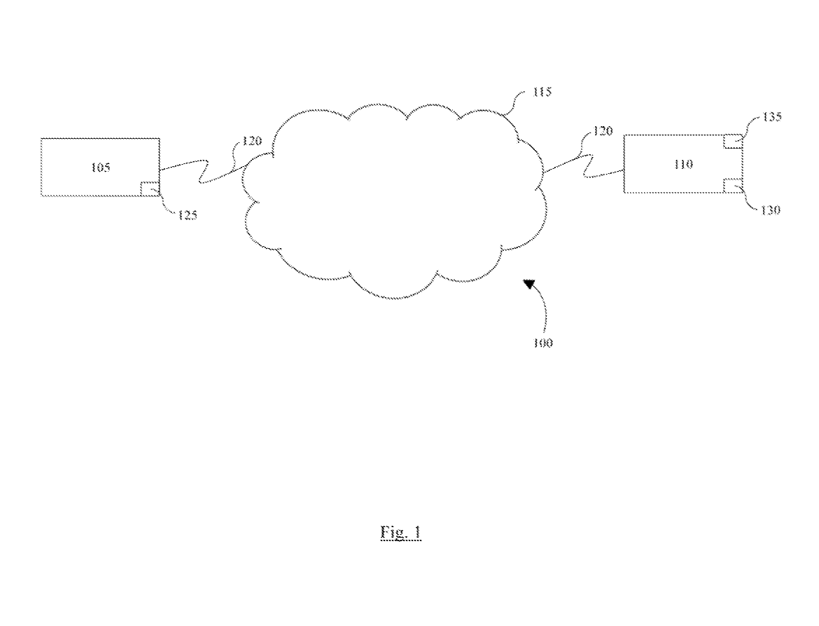

FIG. 1 discloses a system 100 for managing location-based information displayed on an internet website, including, but not limited to, a social network website. As shown, the system 100 includes a client 105 and a server 110 communicatively coupled via a network 115 by communication links 120. The client 105 can include an application programming interface (API) 125 and the server 110 can include a computer readable storage medium 130 and a processor 135. Although the API 125 is shown physically coupled to the client 105, and the computer-readable storage medium 130 and processor 135 are shown physically coupled to the server 110, the system 100 is not so limited. For example, the API 125 can be only communicatively coupled to the client 105, and the computer-readable medium 130 and the processor 135 can be communicatively coupled to the server 110.

The client 105 can be any Internet-based entity or physical commodity capable of communicating with the server 110. For example, the client 105 can be a tangible object such as a computer, smartphone, or disk, or can be an intangible object such as a website. In an embodiment, the client 105 is a website.

The network 115 may be a single network or a plurality of networks of the same or different type. For example, the network 115 may include a local telephone network in connection with a long distance network. Further, the network 115 may be a data network, an intranet, the internet or a telecommunications network in connection with a data network. Any combination of telecommunications and data networks may be used without departing from the spirit and scope of the present application. For purposes of discussion, it will be assumed that the network 115 is the Internet.

The communication links 120 may be any type of connection that allows for the transmission of information. Some examples include conventional telephone lines, fiber optic lines, direct serial connections, cellular telephone connections, satellite communication links, local area networks (LANs), intranets, and the like.

The API 125 can be any interface or protocol that allows the server 130 to communicate with the client 105. The API 125 can facilitate the retrieval of location information from a website, and/or can otherwise allow the client 105 to retrieve any internet-based information for which the API 125 can allow access.

The computer-readable recording medium 130 can store any information including published identifying information received from the client 105 via the network 115. The computer-readable recording medium 130 can include any non-transitory computer-readable recording medium, such as a hard drive, DVD, CD, flash drive, volatile or non-volatile memory, RAM, or any other type of data storage.

The processor 135 can facilitate communication between the various components of the system. The processor 135 can be any type of processor or processors that alone or in combination can facilitate communication within the system 100. For example, the processor 210 can be a desktop or mobile processor, a microprocessor, a single-core or a multi-core processor.

As discussed below, the various components of the system 100 manage internet-based identifying data by periodically requesting and receiving published information relating to identifying data of a business (i.e., “published identifying data”). Identifying data can include, but is not limited to, the location, address, web site address, telephone number, social network account, or any other information that can identify the business or an individual location of the business. The server 110 interacts with the API 125 of a device or website, and periodically retrieves the published identifying data. Alternatively, the server 110 can scrape or crawl the website to obtain the relevant published identifying data. The system can then compare the published identifying data to a queue entry for each store location (i.e., “actual identifying data”) provided by the corporate brand to determine the accuracy of the internet-based information. The system 100 can also distribute the results of this comparison to the end user via the server 110 or client 105, or by any other means. The business can appoint the system 100 as its “agent” for determining the correct published identifying information and, more particularly, determining what information is eventually displayed to an internet user.

In an embodiment, the system 100 can export the results of the comparison to store locator functionality. For example, the system 100 can retrieve all published identifying information, filter the duplicates or erroneous results, and provide the internet user with a single link to the business for each website. For example, the system 100 can retrieve all Facebook® pages for the business, filter the duplicate and erroneous pages, and provide the internet user with one URL linking the user to the correct Facebook® page of the business on a store locator functionality page. For the purposes of discussion, the term “store locator functionality” can include any software-based functionality that allows users to enter location based information (for example, a zip code or address) and receive the location or other identifying information of a store or business at or near that location.

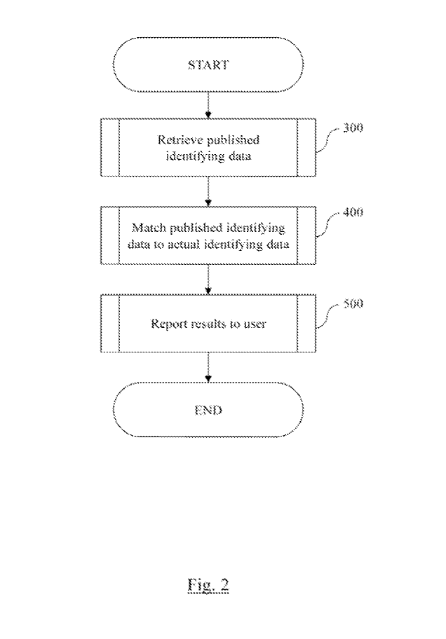

In an embodiment, the system 100 uses a distributed processing methodology where multiple computer systems can simultaneously access each website's API or otherwise search each website to acquire all of the location data found on that website. For example, referring to FIG. 2, the process includes retrieving the data from the client 105 in step 300, matching the data to stored actual identifying data in step 400, and reporting the data in step 500.

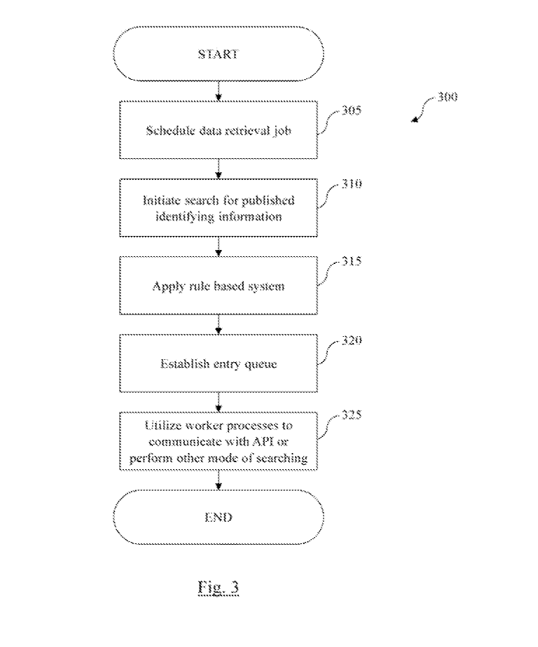

FIG. 3 is a flowchart illustrating the process of retrieving data 300. As shown, the process 300 begins and proceeds to step 305, where the user schedules a data retrieval job. This allows, for example, for the user to select a website for which to retrieve published identifying information, and to input the frequency to acquire the data (e.g., daily, weekly, monthly). A data retrieval job can also be run on-demand to provide instantaneous results at the specific request of a user. The submission of each job can create a job record in a database table that is scanned periodically to determine if new jobs are ready to be executed.

The process can then proceed to step 310, where the system 100 initiates a search for relevant identifying information. For example, the data retrieval job can determine which API 125 of a website to retrieve location information from, or otherwise determine how to search the website.

The process can then apply a rule based system 315 to improve search results. Because certain brands use varying brand names for each store location (e.g., Hardees and Carl's Jr.), a rule based system is used to transform values stored by the client 105 into searchable terms for use in the API call or other search. Rules can be as simple as a function to change a text value to upper case, and/or can be written using a look-ahead left to right (LALR) parser language to transform values based upon more complex requirements.

A queue can then be established in step 320. When a new job is ready to be run, a scheduling program can read the job input (e.g., search terms and search radius), apply the rules from step 315 and generate a queue entry for each business or business location to be searched. The queue can include the store name to search for (based upon the transformational rules applied from step 315), the store's latitude and longitude and/or any API or other search options required.

The system 100 then utilizes worker processes to communicate with the API 125 in step 325. Client processes read the queue and submit the location to a distributed processing engine which communicates to worker processes. Each worker process is responsible for submitting the published identifying data to the API 125 and receiving the response from the API 125. The worker process communicates the response from the client 105 to the distributed processing engine and to the computer-readable storage medium 130, where it is saved in a temporary table for the step of matching the retrieved data to stored location data 400. By adding more worker processes, the data acquisition can be horizontally scaled to handle more searched-for locations, businesses, or stores. Once the data is retrieved by the worker processes in step 325, the process 300 ends.

Once all entries in the queue have been processed using the selected API 125, the actual identifying data is then matched against the published identifying data. This matching process determines which entry of published identifying information in the client 105 database is the most accurate entry, allowing further refinement (deleting locations, updating information or adding missing locations) of the client 105 database.

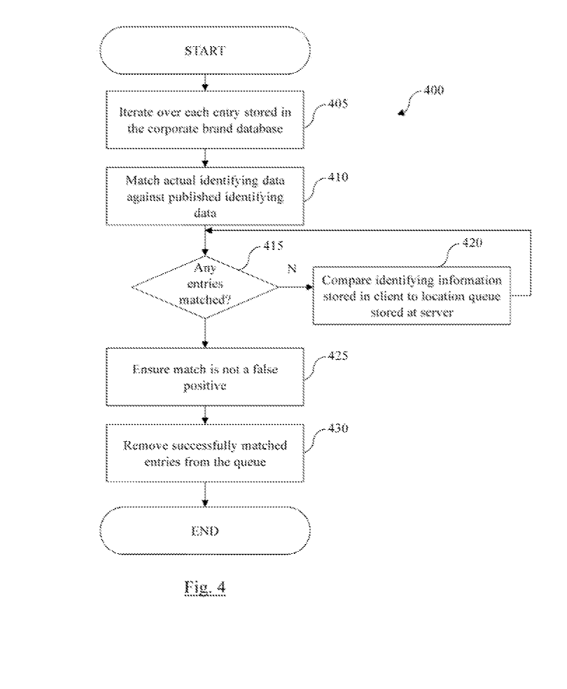

As shown in FIG. 4, the process 400 begins and proceeds to step 405, where the system 100 iterates over each entry in the corporate brand database. In step 410, the process 400 then matches the actual identifying data against the published identifying data. For example, the process 400 performs in step 410 a matching SQL statement to match the actual identifying data against data acquired from a social network.

The SQL statement can use both equality comparisons (comparing the corporate brand address to the social network address) as well as specific geo-dictionary full text search algorithms. These search algorithms include geo-dictionaries that normalize address elements to ensure diverse matching. For example, the algorithms ensure that an address such as “111 Main St” can be matched against “111 Main Street,” or more complex scenarios such as “111 MLK Dr Suite 100, Washington, District of Columbia” matched against “111 Martin Luther King Drive, Washington, DC.” Using the geo-dictionaries, the server 110 can match a single corporate brand location to one or more locations stored by the client 105. Each match can be scored to demonstrate the quality of the match.

The process 400 can then proceed to step 415, where it is determined whether any locations have been matched between, for example, the corporate brand address and the location stored by the client 105. If no locations are matched, the process 400 will attempt at least one more time to match locations by using the latitude and longitude from the location data retrieved from the client 105, in step 420. If a location indeed exists within the client data which has not already been matched against the location queue, the system 100 can search within a predetermined distance between the corporate brand location latitude/longitude and the social network latitude/longitude to determine whether a match exists.

Once a match exists, the process proceeds to step 425 to ensure the match is not a false positive. In this step, the system 100 includes a positive keyword and negative keyword functionality based on, for example, the full text search functionality found in PostgreSQL (http://www.postgresql.org/docs/9.0/static/textsearch-controls.html). Positive and negative keywords are used to limit the results presented to the user, similar to the rule based system applied in step 315.

As each entry is successfully processed, the entry can be removed from the location queue in step 430. For example, the entry can be removed from the queue until the scheduled job is run again based upon the frequency rules. After the successfully matched entries are removed, the process according to FIG. 4 ends.

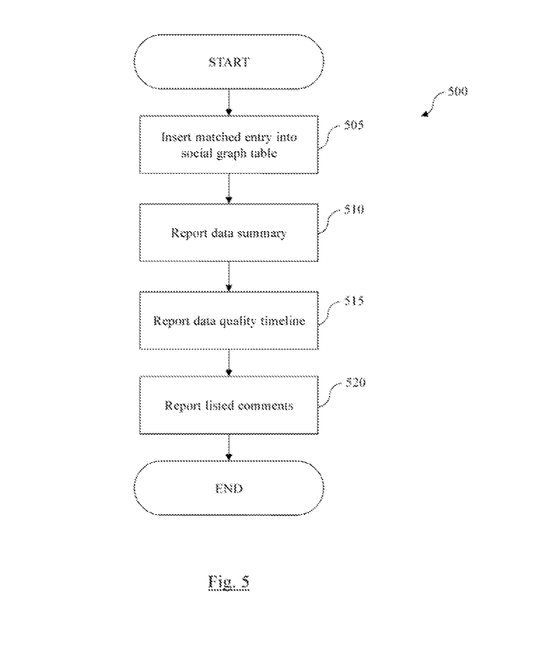

FIG. 5 illustrates a process for reporting the results of the matching process. As shown, the process 500 begins and proceeds to step 505, where each matched entry is inserted into a “socialgraph” table allowing for further reporting and processing. Each row in this table includes a unique identifier provided by the corporate brand and that is tied to the unique identifiers used by each website or other client 105 functionality. In this manner, the corporate brand identifications can be linked to the entries stored by the client 105 since the unique identifier used by each client 105 functionality is used to access that entry's data in the client 105 database.

The process then proceeds to step 510, where the system reports the data summary. This summary includes, for each web site list, the number of duplicate locations, missing locations, locations with bad addresses, poor geocodes (latitude/longitude values), and locations with erroneous phone numbers, for example. The process can then report a data quality timeline in step 515. This timeline includes, for each web site, a list of the same data elements as the data summary, but on a daily basis. The data quality timeline demonstrates how data quality improves or degrades over time. In step 520, the process can also report listed comments or “likes” of a social network client 105. For example, using the matched location data, the system can report the listed comments for specific locations, filtered based upon a geo-qualifier, date, or keyword. The reported comments demonstrate if the correct location in the social data network is being used by consumers who post comments.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method of managing data comprising:
storing actual identifying data of a merchant indicating an actual identification of a storefront or business representing the merchant;
receiving a data retrieval job request from a user requesting a comparison between the actual identifying data and published identifying data representing a published identification of the storefront or business representing the merchant;
receiving the published identifying data from a client;
comparing the published identifying data with the actual identifying data;
determining an accuracy of the published identifying data to obtain a result of the step of comparing; and
transmitting the result.

2. The method of claim 1, wherein the published identifying data is published on a social network or business identifying website accessible via the internet.

3. The method of claim 2, wherein the step of receiving includes receiving the published identifying data from an Application Programming Interface (API) of a website or through web scraping techniques.

4. The method of claim 1, wherein the step of transmitting the result includes transmitting the result to at least one of the user and a store locator functionality.

5. The method of claim 1, wherein the step of receiving a data retrieval job includes receiving a user selection of a website from which to receive the published identifying data.

6. The method of claim 1, wherein the step of receiving the data retrieval job includes receiving a frequency at which the published identifying data is to be received from the network.

7. The method of claim 1, further comprising normalizing the published identifying data prior to the step of comparing.

8. The method of claim 1, wherein the step of comparing includes comparing the published identifying data to a structured query language (SQL) statement representing the actual identifying data.

9. A system of managing data comprising:
a server having stored thereon actual identifying data of a merchant indicating an actual identification of a storefront or business representing the merchant;
a client having published thereon published identifying data representing a published identification of the storefront or business representing the merchant;
a transceiver adapted to receive a data retrieval job request from a user requesting a comparison between the actual identifying data and the published identifying data, and further adapted to transmit a client request to the client requesting the published identifying data from the client,
wherein the server is further adapted to compare the published identifying data with the actual identifying data and determine the accuracy of the published identifying data to obtain a comparison result; and
wherein the transceiver is further adapted to transmit the comparison result.

10. The system of claim 9, wherein the published identifying data is published on a social network or business identifying website accessible via the internet.

11. The system of claim 10, wherein the transceiver is further adapted to receive the published identifying data from an API of a website or through web scraping techniques.

12. The system of claim 9, wherein the transceiver is further adapted to transmit the result to at least one of the user and a store locator functionality.

13. The system of claim 9, wherein the data retrieval job request includes a user selection of a website from which to receive the published location data.

14. The system of claim 9, wherein the data retrieval job request includes a frequency at which the published identifying data is to be received from the network.

15. The system of claim 9, wherein the server is further adapted to normalize the published identifying data prior to comparing the published identifying data to the actual identifying data.

16. The system of claim 9, wherein the server is further adapted to compare the published identifying data to a SQL statement representing the actual identifying data.

17. A non-transitory computer-readable medium operatively coupled to a processor and capable of executing the following:
instructions to store actual identifying data of a merchant indicating an actual identification of a storefront or business representing the merchant;
instructions to receive a data retrieval job request from a user requesting a comparison between the actual identifying data and published identifying data representing a published identification of the storefront or business representing the merchant;
instructions to request the published identifying data from a client;
instructions to compare the published identifying data with the actual identifying data;
instructions to determine an accuracy of the published identifying data to obtain a result of the step of comparing; and
instructions to transmit the result.

18. The non-transitory computer-readable medium of claim 17, wherein the published identifying data is published on a social network or business identifying website accessible via the internet.

19. The non-transitory computer-readable medium of claim 18, wherein the instructions to receive include instructions to receive the published identifying data from an API of a website or through web scraping techniques.

20. The non-transitory computer-readable medium of claim 17, wherein the instructions to transmit the result include instructions to transmit the result to at least one of the user and a store locator functionality.

21. The non-transitory computer-readable medium of claim 17, wherein the instructions to receive a data retrieval job include instructions to receive a user selection of a website from which to receive the published identifying data.

22. The non-transitory computer-readable medium of claim 17, wherein the instructions to receive the data retrieval job include instructions to receive a frequency at which the published identifying data is to be received from the network.

23. The non-transitory computer-readable medium of claim 17, further comprising instructions to normalize the published identifying data prior to comparing the published identifying data with the actual identifying data.

24. The non-transitory computer-readable medium of claim 17, wherein the instructions to compare include instructions to compare the published identifying data to a SQL statement representing the actual identifying data.

25. A method of presenting data on a store locator application comprising:
storing actual identifying data of a merchant indicating an actual identification of a storefront or business representing the merchant;
receiving a data retrieval job request from a user requesting a comparison between the actual identifying data and published identifying data representing a published identification of the storefront or business representing the merchant;
receiving the published identifying data from a client;
comparing the published identifying data with the actual identifying data;
determining an accuracy of the published identifying data to obtain a result of the step of comparing; and
presenting the result on the store locator application.

26. The method of claim 25, wherein the step of presenting the result includes presenting a link on the store locator application.
